(19) United States
(12) Patent Application Publication
(10) Pub. No.: US 2026/0315155 A1
(43) Pub. Date: Oct. 15, 2026

(54) CONTROLLED ACTUATION OF A SURGICAL TOOL

(71) Applicants: Smith & Nephew, Inc., Memphis, TN (US); Smith & Nephew Orthopaedics AG, Zug (CH)

(72) Inventors: Samuel C. Dumpe, Sewickley, PA (US); Riddhit Mitra, Pittsburgh, PA (US); Branislav Jaramaz, Pittsburgh, PA (US); Eric Ashuckian, Pittsburgh, PA (US)

(73) Assignees: Smith & Nephew, Inc., Memphis, TN (US); Smith & Nephew Orthopaedics AG, Zug (CH)

(21) Appl. No.: 19/464,892

(22) Filed: Jan. 30, 2026

Related U.S. Application Data
(60) Provisional application No. 63/762,759, filed on Feb. 25, 2025.

(51) Int. Cl. A61B 34/20; A61B 34/30

(52) U.S. Cl. CPC A61B 34/20; A61B 34/30

(57) ABSTRACT

A system and a method for controlling a surgical tool. Controlling the surgical tool includes detecting a location of a surgical tool in relation to a surgical site. The location is defined by a location data identifying a position and an orientation of the surgical tool in relation to the surgical site. The surgical tool is actuated upon determining that the location data is substantially the same as an actuation location data. The actuation location data defines an actuation position and an actuation orientation of the surgical tool in relation to the surgical site. The surgical tool is configured to actuate in accordance with the actuation location data.

### CROSS-REFERENCE TO RELATED APPLICATIONS

This is a non-provisional of, and claims the benefit of the filing date of, pending U.S. Provisional Patent Application No. 63/762,759, filed Feb. 25, 2025, entitled “Controlled Actuation of a Surgical Tool,” the entirety of which application is incorporated by reference herein.

### BACKGROUND

Surgical tool assisted surgeries, such as, for example, a total knee arthroplasty (TKA), provide a surgeon with an advantage of planning a procedure and viewing a projected outcome of the procedure prior to performing bone resection. One of the challenges to providing a robotically assisted surgery is controlling operation of various surgical hardware components (e.g., a handpiece, surgical tools, etc.) of the surgical system being used to perform such surgery. Conventionally, such components are controlled using a foot pedal that a surgeon can press with their foot to activate and/or deactivate a particular hardware component. The foot pedal may be connected to the surgical system using one or more wires and may include one or more pressable buttons that the surgeon may step on or press (e.g., with their foot) to activate various functions of the hardware component. In the case of a handpiece, such buttons may be pressed to execute variable speed control operation of the cutting tool. However, existing systems lack an ability to control operation of the surgical tool based on a specific location, orientation, etc. of the surgical tool at different times during the surgery, which can lead to undesired consequences, mistakes during surgeries, and injuries to patients.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

In some examples, the present disclosure relates to a computer-implemented method for controlling actuation of a surgical tool (e.g., a drill, an impactor, a cutting tool, etc.) that may be used to perform a surgical procedure (e.g., a total knee arthroplasty, a hip replacement, etc.) at a surgical site (e.g., a knee, a shoulder, etc.). The method may include receiving, using at least one processor, a location data associated with the surgical tool. In some examples, an actuation device may include such processor. The actuation device may be configured to be communicatively and/or mechanically coupled to the surgical tool. The location data may identify a position and an orientation of the surgical tool in relation to the surgical site. Once the location data is received, it may be compared with an actuation location data that defines an actuation position and an actuation orientation of the surgical tool in relation to the surgical site, where the surgical tool may be configured to actuate using the actuation location data. The surgical tool may be configured to be actuated upon determining that the received location data is substantially the same as the actuation location data. Otherwise, actuation of the surgical tool may be prevented upon determining that the location data is different from the actuation location data.

In any preceding or subsequent example, the actuation location data may be at least one of: a stored actuation location data, an actuation location data defined by a surgical treatment plan, or any combination thereof.

In any preceding or subsequent example, comparison of the received location data and actuation location data may include comparing the identified position of the received location data to the actuation position and comparing the identified location of the received location data to the actuation orientation. Actuation of the surgical tool may include actuating the surgical tool upon the identified position of the received location data being substantially the same as the actuation position, and the identified orientation of the received location data being substantially the same as the actuation orientation.

In any preceding or subsequent example, actuation of the surgical tool may be prevented upon at least one of: the identified position of the received location data being different from the actuation position, the identified orientation of the received location data being different from the actuation orientation, or any combination thereof.

In any preceding or subsequent example, at least one of: the identified position of the received location data or the actuation position may be defined by one or more coordinates of the surgical tool in relation to the surgical site. Further, at least one of: the identified orientation of the received location data or the actuation orientation may be defined by at least one of: the one or more coordinates of the surgical tool in relation to the surgical site, a direction of the surgical tool in relation to the surgical site, or any combination thereof.

In any preceding or subsequent example, actuation of the surgical tool may include triggering a supply of power to the surgical tool. The surgical tool may be configured to actuate using the supplied power.

In any preceding or subsequent example, actuation of the surgical tool may include actuating the surgical tool upon determining that the location data is within a predetermined number of degrees of freedom in relation to the actuation location data.

In some examples, the current subject matter relates to a surgical system. The surgical system may include a surgical tool configured for performing a surgery at a surgical site, and an actuation device communicatively coupled to the surgical tool and that may include at least one processor and at least one memory storing instructions that, when executed by the processor, cause the processor to receive a location data associated with the surgical tool, where the location data may identify a position and an orientation of the surgical tool in relation to the surgical site. The processor may further compare the location data with an actuation location data, where the actuation location data may define an actuation position and an actuation orientation of the surgical tool in relation to the surgical site, the surgical tool is configured to actuate using the actuation location data. Upon determining that the location data is substantially the same as the actuation location data, the processor may actuate the surgical tool. Upon determining that the location data is different from the actuation location data, the processor may prevent actuation of the surgical tool.

In any preceding or subsequent example, the actuation location data may be at least one of: stored actuation location data, an actuation location data defined by a surgical treatment plan, or any combination thereof.

In any preceding or subsequent example, comparison of the location data may include comparing the identified position of the received location data to the actuation position and comparing the identified location of the received location data to the actuation orientation. Further, actuation of the surgical tool may include actuating the surgical tool upon the identified position of the received location data being substantially the same as the actuation position, and the identified orientation of the received location data being substantially the same as the actuation orientation. Preventing actuation may include preventing actuation of the surgical tool upon at least one of: the identified position of the received location data being different from the actuation position, the identified orientation of the received location data being different from the actuation orientation, or any combination thereof.

In any preceding or subsequent example, at least one of: the identified position of the received location data or the actuation position may be defined by one or more coordinates of the surgical tool in relation to the surgical site. At least one of: the identified orientation of the received location data or the actuation orientation may be defined by at least one of: the one or more coordinates of the surgical tool in relation to the surgical site, a direction of the surgical tool in relation to the surgical site, or any combination thereof.

In any preceding or subsequent example, actuation may include triggering a supply of power to the surgical tool, wherein the surgical tool is configured to actuate using the supplied power.

In any preceding or subsequent example, actuation may include actuating the surgical tool upon determining that the location data is within a predetermined number of degrees of freedom in relation to the actuation location data.

In some examples, the current subject matter relates to a surgical tool configured for performing a surgery at a surgical site. The surgical tool may include an actuation device configured to receive a location data associated with the surgical tool, the location data identifying a position and an orientation of the surgical tool in relation to the surgical site, compare the location data with an actuation location data, the actuation location data defining an actuation position and an actuation orientation of the surgical tool in relation to the surgical site, the surgical tool is configured to actuate using the actuation location data, actuate the surgical tool upon determining that the location data is substantially the same as the actuation location data, and/or prevent actuation of the surgical tool upon determining that the location data is different from the actuation location data.

In some examples, the current subject matter relates to a computer-implemented method. The method may include detecting, using at least one processor, a location of a surgical tool in relation to a surgical site. The location may be defined by a location data identifying a position and an orientation of the surgical tool in relation to the surgical site. The method may also include actuating the surgical tool upon determining that the location data is substantially the same as an actuation location data. The actuation location data may define an actuation position and an actuation orientation of the surgical tool in relation to the surgical site, where the surgical tool may be configured to actuate using the actuation location data.

In any preceding or subsequent example, the actuation location data may be at least one of: stored actuation location data, an actuation location data defined by a surgical treatment plan, or any combination thereof.

In any preceding or subsequent example, the method may further include preventing actuation of the surgical tool upon determining that the location data is different from the actuation location data. The method may also include comparing the identified position of the received location data to the actuation position and comparing the identified location of the received location data to the actuation orientation.

In any preceding or subsequent example, actuating may include actuating the surgical tool upon the identified position of the received location data being substantially the same as the actuation position, and the identified orientation of the received location data being substantially the same as the actuation orientation.

In any preceding or subsequent example, preventing actuation may include preventing actuation of the surgical tool upon at least one of: the identified position of the received location data being different from the actuation position, the identified orientation of the received location data being different from the actuation orientation, or any combination thereof.

In any preceding or subsequent example, at least one of: the identified position of the received location data or the actuation position may be defined by one or more coordinates of the surgical tool in relation to the surgical site.

In any preceding or subsequent example, at least one of: the identified orientation of the received location data or the actuation orientation may be defined by at least one of: the one or more coordinates of the surgical tool in relation to the surgical site, a direction of the surgical tool in relation to the surgical site, or any combination thereof.

In any preceding or subsequent example, actuating may include triggering a supply of power to the surgical tool, wherein the surgical tool is configured to actuate using the supplied power.

In any preceding or subsequent example, actuating may include actuating the surgical tool upon determining that the location data is within a predetermined number of degrees of freedom in relation to the actuation location data.

Examples of the present disclosure provide numerous advantages. For example, the current subject matter's actuation controlling techniques may allow a more precise control of when a particular surgical tool may be actuated even if a medical professional (e.g., a surgeon, etc.) operating such device performed an action indicative of professional's desire to actuate the device. The current subject matter may prevent actuation of such surgical tool until the surgical tool is properly positioned and oriented with respect to the surgical site. This may reduce the number of surgical errors that may occur when a surgical tool is either improperly positioned and/or oriented.

Further features and advantages of at least some of the examples of the current subject matter, as well as the structure and operation of various examples of the current subject matter, are described in detail below with reference to the accompanying drawings.

### BRIEF DESCRIPTION OF THE DRAWINGS

The accompanying drawings, which are incorporated in and constitute a part of this specification, show certain features of the subject matter disclosed herein and, together with the description, help explain some of the principles associated with the disclosed implementations. In the drawings,

FIG. 1 illustrates an example surgical tool control system, according to some examples of the current subject matter;

FIGS. 2A-B illustrate an example surgical tool, according to some examples of the current subject matter;

FIG. 3 illustrates further details of the surgical tool actuation device, according to some implementations of the current subject matter;

FIG. 4 illustrates a process for controlling operation of the surgical tool, according to some examples of the current subject matter;

FIG. 5 illustrates another example process for controlling operation of the surgical tool, according to some examples of the current subject matter;

FIG. 6 illustrates yet another example process for controlling operation of the surgical tool, according to some examples of the current subject matter;

FIG. 7 illustrates an example of a storage medium to store logic in accordance with one or more features of the present disclosure; and

FIG. 8 illustrates an example computing platform in accordance with one or more features of the present disclosure.

It should be understood that the drawings are not necessarily to scale and that the disclosed examples are sometimes illustrated diagrammatically and/or in partial views. In certain instances, details that are not necessary for an understanding of the disclosed methods and devices or which render other details difficult to perceive may have been omitted. It should be further understood that this disclosure is not limited to the particular examples illustrated herein. In the drawings, like numbers refer to like elements throughout unless otherwise noted.

### DETAILED DESCRIPTION

To address these and potentially other deficiencies of currently available solutions, one or more implementations of the current subject matter relate to methods, systems, articles of manufacture, and the like that can, among other possible advantages, provide a system and a method for controlling operation of a surgical tool.

In some examples, the current subject matter relates to a surgical tool control system that may be configured to determine whether or not to allow and/or prevent actuation, operation, and/or continuous operation of a surgical tool at any time during a surgical procedure. This determination may be made on a continuous basis, at certain times (e.g., upon detecting a desire to use the surgical tool, etc.) during the surgical procedure, and/or at any other desired times. The determination may be based on determination location data associated with the surgical tool. The location data may include, for example, coordinates of the surgical tool and/or orientation direction of the surgical tool with respect to the surgical site and/or any other reference point in the surgical theater (e.g., operating room, etc.). The location data may, for example, be determined using a tracking and/or navigation system that may be configured to track and/or determine/detect positioning of the surgical tool. Alternatively, or in addition, the location data may be determined using a surgical tool actuation device that may be communicatively and/or mechanically coupled to the surgical tool.

The detected/determined location data may be compared to an actuation location data to determine whether the surgical tool is properly positioned. The actuation location data may include actuation coordinates and actuation orientation direction, using which, it may be known that the surgical tool will be actuated/operate/continue to operate. If the detected/determined location data substantially (e.g., within a predetermined number of degrees of freedom) matches the actuation location data, then the surgical tool may be allowed to actuate/operate/continue to operate. Otherwise, the surgical tool may be prevented from actuation/operation/continuous operation. The actuation location data may be retrieved from a storage location and/or defined and/or determined from a surgical treatment plan that may define the surgical procedure and its various details. The above may be used for controlling of any type of surgical tool that may be used for any type of surgical procedure.

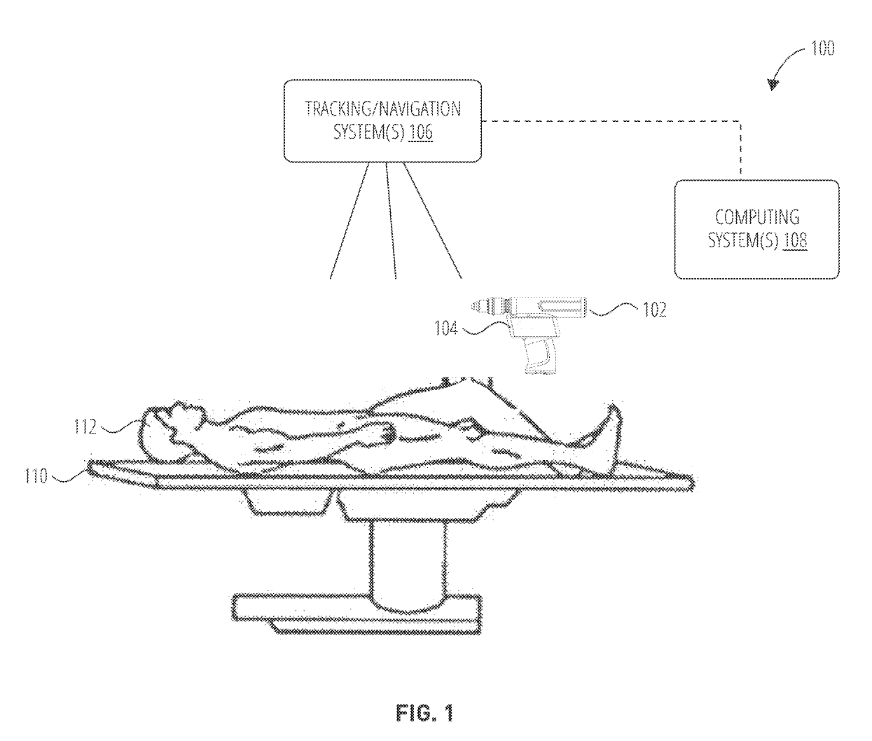

FIG. 1 illustrates an example surgical tool control system 100, according to some examples of the current subject matter. The system 100 may be used to perform various surgical procedures, e.g., positioning and/or implanting an implant into a bone of a patient, a total knee arthroplasty (TKA), a total hip arthroplasty (THA), and/or any other surgical procedures. In addition to surgical components that may be used to perform a surgical procedure, the system 100 may include various computing components that may assist a medical professional (e.g., a surgeon) during such surgical procedure.

The surgical tool control system 100 may, among various surgical components (not shown in FIG. 1), include a surgical tool 102, one or more tracking/navigation system(s) 106, and one or more computing system(s) 108. The surgical tool 102 may include a surgical tool actuation device 104 that may be used to control actuation of the surgical tool 102. The surgical tool actuation device 104 may be communicatively and/or mechanically coupled to the surgical tool 102 and/or be integrated into the surgical tool 102. The tracking/navigation system(s) 106 may be communicatively coupled to the computing system(s) 108 (via one or more wired connections and/or wireless connections). The surgical tool 102 may also be communicatively coupled to the tracking/navigation system(s) 106 and/or computing system(s) 108. The surgical tool 102 may include, for example, but not limited to, an impactor device, a surgical saw, a surgical drill, and/or any other device that may be used in connection with one or more surgical procedures that may be performed on subject 112 that may be positioned on a surgical table 110 during such surgical procedure(s).

The tracking/navigation system(s) 106 may include one or more optical devices and/or one or more position detecting/tracking devices. For example, the tracking/navigation system(s) 106 may include, but not limited to one or more active sensors, passive sensors, optical sensors, electromagnetic sensors, infrared camera(s) and/or infrared camera systems, and/or any other suitable systems/devices. The tracking/navigation system(s) 106 may use one or more such devices to collect real-time position (e.g., coordinates, etc.) and/or orientation (e.g., direction, etc.) data that defines and/or locates subject 112 anatomy and/or surgical tool 102. In addition to positional data, data from the tracking/navigation system(s) 106 may also be used to determine velocity/acceleration of anatomy/surgical devices (e.g., surgical tool 102), which may be used for tool control. The position of the surgical tool 102 may be determined vis-a-vis subject 112 and/or any other tools/instruments used prior, during, and/or after a surgical procedure. Various types of tracking systems may be used in various examples of the current subject matter including, but not limited to, infrared (IR) tracking systems, electromagnetic (EM) tracking systems, video or image-based tracking systems, ultrasound registration and tracking systems, and/or any other types of tracking systems. In some examples, the data detected by the tracking/navigation system(s) 106 may allow the computing system(s) 108 to determine whether surgical tool 102 may be safely actuated to perform the intended surgical procedure at the surgical site (e.g., a knee, etc.), determine position of various objects, prevent collision(s), etc.

Any suitable tracking system may be used for tracking surgical tool 102, patient anatomy, etc. For instance, a combination of IR and visible light cameras may be used in an array. Various illumination sources, such as, an IR LED light source, may illuminate the scene allowing three-dimensional imaging to occur. In some examples, this may include stereoscopic, tri-scopic, quad-scopic, etc. imaging. In addition to the camera array, which in some examples, may be affixed to a cart, additional cameras may be placed throughout the surgical theatre. For instance, handheld tools and/or headsets worn by operators/surgeons may include imaging capability that communicates images back to a central processor to correlate those images with images captured by the camera array. This may give a more robust image of the environment for modeling using multiple perspectives. Further, some imaging devices may be of suitable resolution and/or have a suitable perspective on the scene to pick up information stored in quick response (QR) codes and/or barcodes. This may be helpful in identifying specific objects that might not be manually registered with the system. In some examples, the camera and/or any other sensors may be mounted directly on the surgical tool 102 and/or surgical tool actuation device 104.

The tracking/navigation system(s) 106 may also provide the surgeon with intraoperative, real-time visualization for the patient's bone, cartilage, muscle, nervous, and/or vascular tissues surrounding the surgical area. Examples of systems that may be employed for tissue navigation include, but are not limited to, fluorescent imaging systems, ultrasound systems, etc. This information may be used by the surgical tool actuation device 104 and/or computing system(s) 108 to determine whether the surgical tool 102 may be safely actuated to perform an intended surgical procedure (even if the surgeon indicated surgeon's intent to use to the surgical tool 102, e.g., by pressing a trigger on the surgical tool 102, pressing a foot pedal, etc.).

The computing system(s) 108 may be configured to perform analysis of data received from tracking/navigation system(s) 106 and/or surgical tool 102 and/or any other components of the surgical tool control system 100, provide communication and/or control signals to the surgical tool 102 and/or surgical tool actuation device 104, as well as receive and analyze data/information related to the position/orientation of the surgical tool 102 from the tracking/navigation system(s) 106 and/or from the surgical tool 102. In some examples, the computing system(s) 108 may include multiple computing subsystems, such as, for example, but not limited to a computing subsystem configured to determine navigation information (e.g., patient position information, surgical tool information, etc.), another computing subsystem configured to compute remote control information related to operation of the surgical tool 102 according to a surgical plan for the intended surgical procedure, a further computing subsystem that may be responsible for storage and/or retrieval of various data/information related to the surgical procedure, etc. As can be understood, the computing system(s) 108 may be arranged and/or configured in any desired way.

One or more components of the surgical tool control system 100 may be communicatively coupled using one or more communications networks. The communications networks may include one or more of the following: a wired network, a wireless network, a metropolitan area network ("MAN"), a local area network ("LAN"), a wide area network ("WAN"), a virtual local area network ("VLAN"), an internet, an extranet, an intranet, and/or any other type of network and/or any combination thereof.

Further, one or more components of the system 100 may include any combination of hardware and/or software. In some examples, one or more components of the system may be disposed on one or more computing devices, such as, server(s), database(s), personal computer(s), laptop(s), cellular telephone(s), smartphone(s), tablet computer(s), virtual reality devices, and/or any other computing devices and/or any combination thereof. In some examples, one or more components of the system may be disposed on a single computing device and/or may be part of a single communications network. Alternatively, or in addition to, such devices may be separately located from one another. A device may be a computing processor, a memory, a software functionality, a routine, a procedure, a call, and/or any combination thereof that may be configured to execute a particular function associated with interface and/or document certification processes disclosed herein.

In some examples, one or more components of the system 100 may include network-enabled computers. As referred to herein, a network-enabled computer may include, but is not limited to a computer device, or communications device including, e.g., a server, a network appliance, a personal computer, a workstation, a phone, a smartphone, a handheld PC, a personal digital assistant, a thin client, a fat client, an Internet browser, or other device. One or more components of the system may also be mobile computing devices, for example, an iPhone, iPod, iPad from Apple® and/or any other suitable device running Apple’s iOS® operating system, any device running Microsoft's Windows®. Mobile operating system, any device running Google's Android® operating system, and/or any other suitable mobile computing device, such as a smartphone, a tablet, or like wearable mobile device.

One or more components of the system 100, and in particular computing system(s) 108, may include a processor and a memory, and it is understood that the processing circuitry may contain additional components, including processors, memories, error and parity/CRC checkers, data encoders, anti-collision algorithms, controllers, command decoders, security primitives and tamper-proofing hardware, as necessary to perform the interface and/or document certification functions described herein. One or more components of the system may further include one or more displays and/or one or more input devices. The displays may be any type of devices for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

In some examples, one or more components of the system 100, e.g., computing system(s) 108, may execute one or more applications, such as software applications, that enable, for instance, network communications with one or more components of system and transmit and/or receive data.

One or more components of the surgical tool control system 100 may include and/or be in communication with one or more servers via one or more networks and may operate as a respective front-end to back-end pair with one or more servers. One or more components of the system may transmit, for example from a mobile device application (e.g., executing on one or more user devices, components, etc.), one or more requests to one or more servers. The requests may be associated with retrieving data from servers. The servers may receive the requests from the components of the system. Based on the requests, servers may be configured to retrieve the requested data from one or more storage locations. Based on receipt of the requested data from the databases, the servers may be configured to transmit the received data to one or more components of the system, where the received data may be responsive to one or more requests.

The system 100 may include one or more networks. In some examples, networks may be one or more of a wireless network, a wired network or any combination of wireless network and wired network and may be configured to connect the components of the system and/or the components of the system to one or more servers. For example, the networks may include one or more of a fiber optics network, a passive optical network, a cable network, an Internet network, a satellite network, a wireless local area network (LAN), a metropolitan area network (MAN), a wide area network (WAN), a virtual local area network (VLAN), an extranet, an intranet, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 502.11b, 502.15.1, 502.11n and 502.11g, Bluetooth, NFC, Radio Frequency Identification (RFID), Wi-Fi, and/or any other type of network and/or any combination thereof.

In addition, the networks may include, without limitation, telephone lines, fiber optics, IEEE Ethernet 502.3, a wide area network, a wireless personal area network, a LAN, or a global network such as the Internet. Further, the networks may support an Internet network, a wireless communication network, a cellular network, or the like, or any combination thereof. The networks may further include one network, or any number of the exemplary types of networks mentioned above, operating as a stand-alone network or in cooperation with each other. The networks may utilize one or more protocols of one or more network elements to which they are communicatively coupled. The networks may translate to or from other protocols to one or more protocols of network devices. The networks may include a plurality of interconnected networks, such as, for example, the Internet, a service provider's network, a cable television network, corporate networks, such as credit card association networks, and home networks.

The system 100 may include one or more servers, which may include one or more processors that may be coupled to memory. Servers may be configured as a central system, server or platform to control and call various data at different times to execute a plurality of workflow actions. Servers may be configured to connect to the one or more databases. Servers may be incorporated into and/or communicatively coupled to at least one of the components of the system.

Further, one or more components of the system 100 may be configured to execute one or more actions using one or more containers. In some examples, each action may be executed using its own container. A container may refer to a standard unit of software that may be configured to include the code that may be needed to execute the action along with all its dependencies. This may allow execution of actions to run quickly and reliably.

In operation, the surgical tool control system 100, using its tracking/navigation system(s) 106, may be configured to detect and/or determine (e.g., using computing system(s) 108) location data of the surgical tool 102. The location data of the surgical tool 102 may include, for example, one or more position coordinates of the surgical tool 102 and/or an orientation of the surgical tool 102. The surgical tool 102 position coordinates may include coordinates determined with respect to a particular surgical site (e.g., a knee of the subject 112 positioned on the surgical table 110), coordinates determined with respect to a predetermined reference point (e.g., surgical table 110 and/or any other reference point in the surgical theater), and/or any other coordinates. Similarly, the orientation of the surgical tool 102 may include a direction and/or orientation of the surgical tool 102 with respect to a particular surgical site, direction/orientation determined with respect to a predetermined reference point, and/or any other direction/orientation. In some examples, the position coordinates and/or direction/orientation of the surgical tool 102 may be determined using proximal and/or distal ends of the surgical tool 102 and/or any other point on the surgical tool 102. For instance, a proximate end of the surgical tool 102 (e.g., which may correspond to a point of attachment of various surgical instruments, tools, attachments, etc.) may be used to determine where the surgical tool 102 is locate and in which direction it is pointed. As can be understood, any other way of determining the location data of the surgical tool 102 may be possible.

In some examples, the location data of the surgical tool 102 may be determined and/or communicated to the tracking/navigation system(s) 106 and/or computing system(s) 108 by the surgical tool actuation device 104 that may be coupled to and/or integrated with the surgical tool 102. The surgical tool actuation device 104 may be configured to include various location data determination hardware and/or software, which may include, for example, but not limited to, accelerometer(s), infrared sensor(s), optical sensor(s), and/or any other components. Alternatively, or in addition, the tracking/navigation system(s) 106 may be configured to determine location data of the surgical tool actuation device 104 and provide such information to the computing system(s) 108, which may, in turn, determine location data of the surgical tool 102.

In some examples, the location data of the surgical tool 102 (and/or surgical tool actuation device 104) may be continuously updated with every movement and/or placement of the surgical tool 102. This may allow real-time determination of the location data, thus, real-time control of actuation of the surgical tool 102, thereby preventing inadvertent and/or improper actuations of the surgical tool 102, hence, preventing injury to the subject 112. For example, during a surgical procedure, the surgeon, while pressing an actuation trigger on the surgical tool 102 (e.g., a surgical impactor), moves the surgical tool 102 causing it to no longer be aligned with a position and/or a direction for positioning of an implant. The tracking/navigation system(s) 106 may be configured to detect a location data associated with the new position/direction of the surgical tool 102 and provide it to the computing system(s) 108. Alternatively, or in addition, the surgical tool actuation device 104 may be configured to detect such location data and provide it to the tracking/navigation system(s) 106 and/or computing system(s) 108. The computing system(s) 108 may be configured to process the received location data and generate an instruction to the surgical tool actuation device 104 to prevent actuation and/or operation of the surgical tool 102. Alternatively, or in addition, the surgical tool actuation device 104 may be configured to automatically prevent actuation and/or operation of the surgical tool 102 upon determining its location data. The surgical tool actuation device 104 may be configured to do so with and/or without communication with the tracking/navigation system(s) 106 and/or the computing system(s) 108.

In some examples, to prevent actuation and/or operation of the surgical tool 102, the surgical tool actuation device 104 may be configured to prevent supply of power to the surgical tool 102 that may be needed for its operation and/or continuous operation. Alternatively, or in addition, the surgical tool actuation device 104 may be configured to mechanically prevent operation and/or continuous operation of the surgical tool 102 (e.g., by mechanically preventing compression and/or squeezing of a trigger on an impactor surgical tool, etc.). As can be understood, any other ways of preventing actuation and/or operation of the surgical tool 102 are possible.

To determine whether the surgical tool 102 can be actuated and/or operated, the computing system(s) 108 may be configured to compare the determined and/or detected location data with a stored actuation location data. The stored actuation location data may define specific coordinates and/or direction of the surgical tool 102 at which the surgical tool 102 is allowed to be actuated/operated. The stored actuation location data may be stored in a storage location that may be communicatively coupled to the computing system(s) 108. For example, the stored actuation location data may be associated with a specific surgical procedure (e.g., a knee replacement, etc.), where one or more locations, i.e., positions and/or directions, at each stage of the surgical procedure may be pre-defined and thus, stored in the storage location. Alternatively, or in addition, a surgical plan associated with a surgical procedure may define and/or may be used to determine specific locations of the surgical tool 102 at one or more stages during such surgical procedure. In some examples, one or more machine learning models may be used to analyze the surgical plan, information about subject 112, specific surgical procedure, and/or any other information and determine specific locations of the surgical tool 102 for each stage of the surgical procedure. The machine learning model may have been trained using one or more historical location data associated with surgical procedures of the same type as the current surgical procedure. The machine learning model may be a large language model, a generative artificial intelligence model, and/or any other machine learning mode. It may be part of the computing system(s) 108 and/or be an external machine learning model.

To perform comparison of the determined/detected location data with the actuation location data, the computing system(s) 108 may be configured to compare the determined/detected position coordinates (e.g., x1, y1, z1) of the determined/detected location data of the surgical tool 102 in the surgical theater (e.g., environment of the system 100) to the respective actuation position coordinates (e.g., x0, y0, z0) of the actuation location data. It may also perform comparison of the determined/detected direction (e.g., d1) of the determined/detected location data of the surgical tool 102 in the surgical theater to the respective actuation direction (e.g., d0) of the actuation location data. As discussed herein, the coordinates/direction may be coordinates/direction with respect to any reference point in the surgical theater (e.g., a surgical site, etc.). The reference point may be a static, non-moving reference point (e.g., the surgical table 110), a dynamic, moving reference point (e.g., subject 112 bone, tissue, etc.).

The comparison may result in a determination of actuation or preventing actuation of the surgical tool 102. For instance, the computing system(s) 108 may trigger surgical tool actuation device 104 to prevent actuation/operation of the surgical tool 102 upon determining that a match exists between determined/detected coordinates of the surgical tool 102 and actuation coordinates but no match is found between determined/detected direction of the surgical tool 102 actuation direction. Further, if one or more of the determined/detected coordinates do not match the respective actuation coordinates (e.g., x1 matches x0, y1 matches y0, but z1 does not match z0), the computing system(s) 108 may trigger the surgical tool actuation device 104 to prevent actuation of the surgical tool 102. Similarly, if all determined/detected and actuation coordinates match but detected/detected and actuation directions do not (e.g., d1 does not match d0), the computing system(s) 108 may trigger surgical tool actuation device 104 to prevent actuation of the surgical tool 102. However, if a match is found between respective determined/detected coordinates/direction and actuation coordinates/direction (e.g., x1 matches x0, y1 matches y0, z1 matches z0, d1 matches d0), the computing system(s) 108 may trigger the surgical tool actuation device 104 to allow actuation/operation of the surgical tool 102.

In some examples, the computing system(s) 108 may allow actuation/operation of the surgical tool 102 upon determining that the determined/detected location data associated with the surgical tool 102 is substantially the same as and/or within a predetermined number of degrees of freedom (e.g., 3-6 degrees of freedom) from the stored actuation location data. For instance, the computing system(s) 108 may determine that some of the determined/detected coordinates match the actuation coordinates (e.g., x1 matches x0, y1 matches y0) and another detected/determined coordinate (e.g., z1) is within a predetermined threshold (e.g., 1 millimeter) of a corresponding actuation coordinate (e.g., z0), and that determined/detected and actuation directions match. In this case, the computing system(s) 108 may determine that the determined/detected location data is within a predetermined number of degrees of freedom of the actuation location data, and thus, may transmit appropriate instructions to the surgical tool actuation device 104 to allow actuation and/or actuate the surgical tool 102. Alternatively, or in addition, the system 100 may be configured to ensure strict compliance of the determined/detected location data with the actuation location data (i.e., 0 degrees of freedom compliance).

In some examples, the system 100 may be configured to allow for a variety of match tolerances between the determined/detected location data and the actuation location data. The tolerances may be defined in accordance with a specific surgical procedure, health metrics associated with the specific subject 112, surgical tool 102, and/or any other factors.

As discussed herein, once the computing system(s) 108 determines that the determined/detected location data substantially matches (e.g., within a predetermined number of degrees of freedom, etc.) the actuation location data for the surgical tool 102, the computing system(s) 108 may transmit appropriate instruction(s) to the surgical tool actuation device 104 to allow actuation/operation of the surgical tool 102 and/or actuate/operate the surgical tool 102 and/or no longer prevent the surgical tool 102 from actuating/operating. This may include allowing a supply of power to the surgical tool 102 so that the surgical tool 102 may actuate/operate. Alternatively, or in addition, the surgical tool actuation device 104 may be the actuator using which the surgical tool 102 may operate. For example, the surgical tool actuation device 104 may be an electric direct current (DC) motor, a piezoelectric motor, a solenoid, a pneumatic actuator, a hydraulic actuator, an electromagnetic solenoid, a linear motor, and/or any other type of linear actuator, and/or any other motor/actuator, and/or any combination thereof. In some non-limiting examples, the surgical tool 102 may be configured to include a Hall-effect sensor and/or any other magnetic sensing-based mechanism(s) that may trigger actuation of the surgical tool upon detection of changes in magnetic field in such magnetic sensing-based mechanism(s). The surgical tool actuation device 104 may be configured to control actuation/operation of the surgical tool 102 through varying of magnetic field in the magnetic sensing-base mechanism(s). In yet further non-limiting examples, the surgical tool actuation device 104 may be configured to control and/or modulate an external magnetic field (such as, for instance, by altering physical positions of various magnetic and/or electromagnetic components within the surgical tool actuation device 104) that may be applied to the magnetic sensing-based mechanism(s) within the surgical tool 102 to trigger its actuation/operation and/or prevent its actuation/operation. Alternatively, or in addition, the surgical tool actuation device 104 may control/modulate external magnetic field that may be directly (e.g., without applying such magnetic field to the magnet/electromagnet-based trigger of the surgical tool 102) applied to the surgical tool 102 to trigger its actuation/operation and/or prevent its actuation/operation.

In some examples, the surgical tool actuation device 104 may be configured to include one or more capabilities of the tracking/navigation system(s) 106 and/or computing system(s) 108 discussed herein. For instance, the surgical tool actuation device 104 may determine and/or detect (e.g., using one or more sensors, etc.) location data of the surgical tool 102 (e.g., coordinates in space, direction, etc.), process such location data to determine whether it matches the actuation location data (which it may retrieve from an external and/or an internal source), and determine whether actuation/operation of the surgical tool 102 may be performed. The surgical tool actuation device 104 may also perform continuous real-time tracking of the location data of the surgical tool 102 and determine, in real-time, whether, based on the tracked location data, continuous actuation/operation of the surgical tool 102 should be allowed/performed.

In some examples, the actuation/operation of the surgical tool 102 may be controlled via one or more inputs from the user of the surgical tool 102 (e.g., a surgeon). Such inputs may include, for example, but are not limited to, a push button, a trigger, a foot pedal, and/or any other device (e.g., electrical, mechanical, electro-mechanical, etc.).

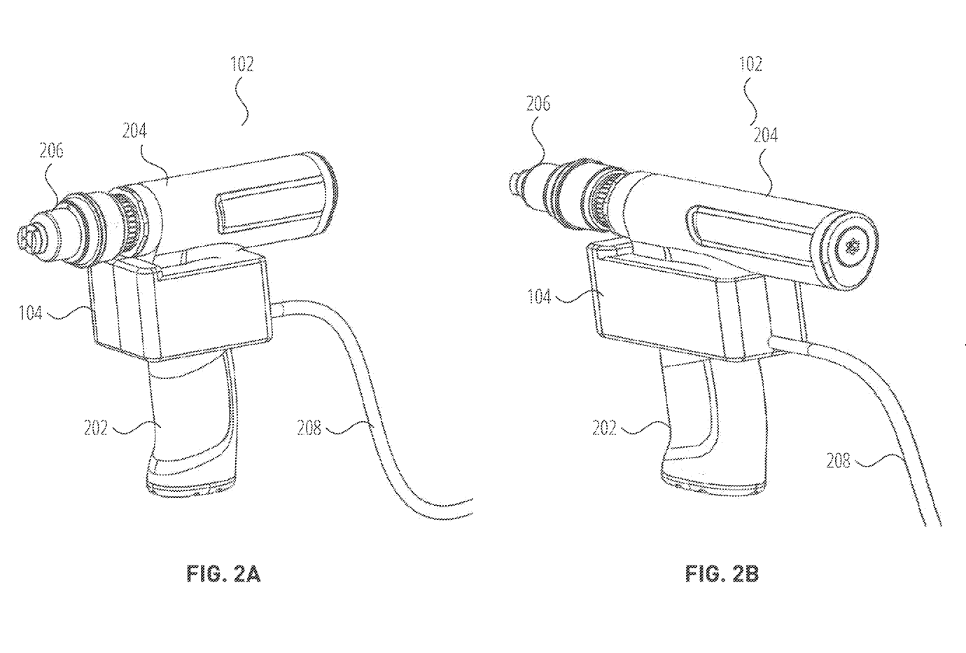

FIGS. 2A-B illustrate an example surgical tool 102, according to some examples of the current subject matter. The surgical tool 102 may be a surgical drill, an impactor, a surgical cutting tool, and/or any other surgical instrument and/or device. FIG. 2A is a front perspective view of the surgical tool 102 and FIG. 2B is a rear perspective of the surgical tool 102. As can be understood, the surgical tool 102 may be any desired surgical device, e.g., an impactor, a drill, a cutting instrument, and/or any other surgical device and/or instrument and/or any combination thereof.

The surgical tool housing 204 may be configured to house various electrical, mechanical, electromechanical, etc. components of the surgical tool 102 that may be used by the surgical tool 102 for performance of a specific surgical procedure. The one or more tool attachments (e.g., a drill, a cutting blade, etc.) may be coupled to the distal end 206 of the surgical tool housing 204. The distal end 206 may include one or more attachment mechanisms (e.g., clamps, latches, etc.) for coupling such tool attachments.

As shown in FIGS. 2A-B, the surgical tool 102 may include a handle 202, a surgical tool housing 204, a distal end 206, and an optional connector(s) 208. The surgical tool 102 may also be coupled to the surgical tool actuation device 104, which may be used to control actuation and/or operation of the surgical tool 102, as discussed herein. The handle 202 may be used by the user (e.g., surgeon, etc.) to hold the device during a surgical procedure. In some examples, the handle 202 may also include a trigger (not shown in FIGS. 2A-B), which may be used to trigger actuation and/or operation of the surgical tool 102. The surgical tool actuation device 104 may be configured to control operation of the trigger by, for example, but not limited to, controlling supply of power through the trigger to cause actuation and/or operation and/or preventing actuation and/or operation of the surgical tool 102, mechanically controlling movement of the trigger to allow and/or prevent actuation/operation of the surgical tool 102, etc. As can be understood, any desired way of controlling operation of the surgical tool 102 through the surgical tool actuation device 104 is possible.

Alternatively, or in addition, the surgical tool 102 may be controlled using an external mechanism, such as, for example, a foot pedal, a push button, etc., where such external mechanism may be actuated (e.g., by pressing the foot pedal, pushing the push button, etc.) causing power to be supplied to the surgical tool actuation device 104 via the connector(s) 208. Upon receiving power (e.g., through actuation of the external mechanism), via the connector(s) 208, the surgical tool actuation device 104 may be configured to determine whether to allow or prevent actuation and/or operation of the surgical tool 102, as discussed herein.

For instance, the user of the system 100 may actuate the external mechanism (e.g., press the foot pedal), thereby supplying power to the surgical tool actuation device 104. Upon receipt of the power, the surgical tool actuation device 104 and/or the computing system(s) 108 may determine and/or detect location data of the surgical tool 102 with respect to the surgical site and/or any other reference point in the system 100. The determined/detected location data may then be compared to the actuation location data to determine whether the surgical tool 102 is properly positioned and thus, may be allowed to actuate/operate/continue to operate. If the determined/detected location data substantially matches the actuation location data (e.g., within a predetermined number of degrees of freedom), the surgical tool actuation device 104 may allow the surgical tool 102 to actuate/operate/continue to operate. Otherwise, the surgical tool actuation device 104 may prevent actuation/operation/continuous operation of the surgical tool 102 even though the user of the surgical tool 102 has indicated user's intent to use the surgical tool 102 (e.g., by pushing the external mechanism).

As discussed herein, the determined/detected location data may be determined and/or detected by the surgical tool actuation device 104, tracking/navigation system(s) 106, and/or computing system(s) 108. The processing of the determined/detected location data may be performed by the computing system(s) 108 and/or by the surgical tool actuation device 104. If the processing (e.g., comparison of determined/detected location data and the actuation location data) is performed by the computing system(s) 108, the computing system(s) 108 may be configured to transmit appropriate actuation/operation instructions to the surgical tool actuation device 104 via the connector(s) 208. Alternatively, or in addition, the surgical tool actuation device 104 may be configured to perform processing of the determined/detected location data with and/or without the use of the tracking/navigation system(s) 106 and/or computing system(s) 108.

In some examples, the system 100 may provide a visual and/or audial indication to the user to indicate that the surgical tool 102 needs to be properly positioned for actuation/operation/continuous operation. The computing system(s) 108 may be configured to provide visual and/or audial instructions to the user on how to properly position the surgical tool 102.

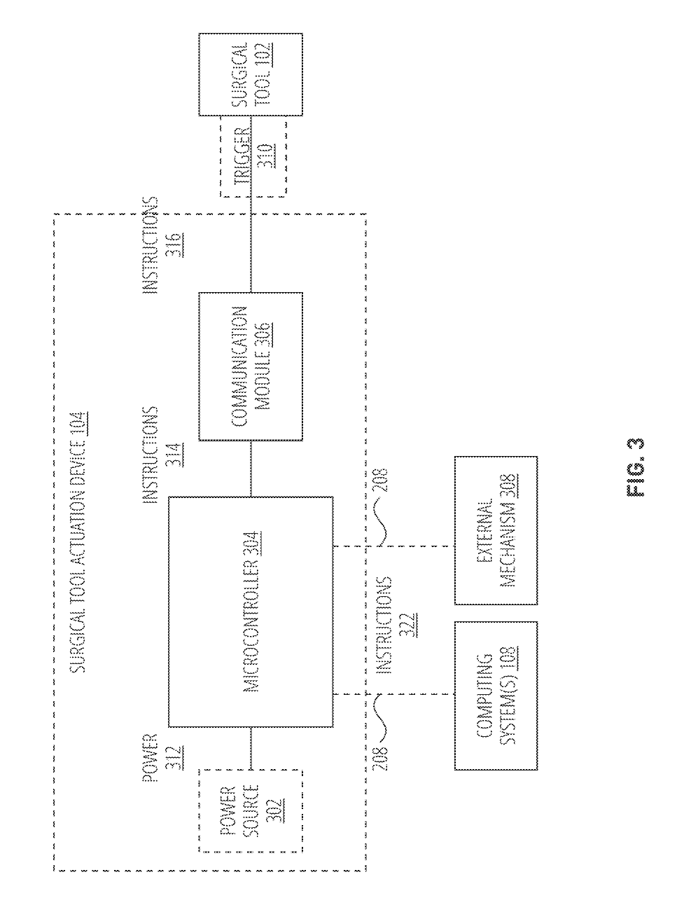

FIG. 3 illustrates further details of the surgical tool actuation device 104, according to some implementations of the current subject matter. As shown in FIG. 3, the surgical tool actuation device 104 may include a power source 302, a microcontroller 304, and a communication module 306. In some examples, the power source 302 may be optional and the surgical tool actuation device 104 may be configured to receive power via one or more connector(s) 208 from an external power source (e.g., via external mechanism 308). Alternatively, or in addition, the surgical tool actuation device 104 may be coupled to a power source of the surgical tool 102 and use its power to control actuation/operation/continuous operation of the surgical tool 102.

The power source 302 may be communicatively coupled to and may provide power 312 the microcontroller 304. The power 312 may be provided using one or more wired and/or wireless connections between the power source 302 and microcontroller 304. Alternatively, or in addition, the power source 302 may be incorporated and/or integrated into the microcontroller 304. The power source 302 may be any type of power source (e.g., an alternating current power source, a direct current power source, a battery, a rechargeable battery, etc.).

The microcontroller 304 may be communicatively coupled to the communication module 306. The microcontroller 304 and the communication module 306 may be coupled using a wired and/or wireless connection. The microcontroller 304 may use the connection with the communication module 306 to transmit and/or receive one or more communication instructions 314. The instructions 314 may include data, information, etc. containing instructions to the surgical tool 102 (and/or trigger 310) to actuate, operate and/or prevent actuation/operation/continuous operation of the surgical tool 102. The instructions 314 may be received by the communication module 306 and transmitted to the surgical tool 102 via a communication link 316. The communication link 316 may be a wireless communication link and/or a wired communication link. In some examples, the communication module 306 may be incorporated and/or integrated into the microcontroller 304, where the microcontroller 304 may then transmit, via the communication link 316, instructions to the surgical tool 102 to actuate, operate and/or prevent actuation/operation/continuous operation of the surgical tool 102.

The microcontroller 304 may also be communicatively coupled to the external mechanism 308 and/or computing system(s) 108 via one or more connector(s) 208. The communicative coupling of the microcontroller 304 and the external mechanism 308 may be using a wireless communication link, which may, for example, include any desired wireless communication protocols, e.g., WiFi, Bluetooth, IOlink, Zigbee, cellular (e.g., 4G LTE, 4G LTE-A, 5G, etc.). The external mechanism 308 may include various processing and/or communication circuitry that may be used to generate and/or transmit various wireless instructions (e.g., instructions 322) to the microcontroller 304. The instructions 322 may include data, information, etc. that may be used by the microcontroller 304 to determine whether to actuate, operate and/or prevent actuation/operation/continuous operation of the surgical tool 102. By way of a non-limiting example, the instructions 322 may also include turning on the surgical tool 102, increasing operational speed of the surgical tool 102, decreasing operational speed of the surgical tool 102, etc.

In some examples, the external mechanism 308 may be actuated and/or activated using any desired methods (e.g., push button, foot pedal, etc.). This may cause one or more of its circuitry to generate one or more instructions 322 (e.g., indication of a desire to turn on the surgical tool 102) and one or more of its transmitting circuitry (not shown in FIG. 3) to transmit the generated instructions 322 to the microcontroller 304 for further processing and, eventually, transmitting to the surgical tool 102 via the communication module 306.

In some examples, the microcontroller 304 may include a sensing circuit and/or component that may be configured to receive instructions 322 from the external mechanism 308 and interpret the signals to determine action that may need to be performed by the microcontroller 304. For example, the instructions 322 may contain information indicating that the external mechanism 308 was double pressed by the trigger 310. The sensing circuit of the microcontroller 304 may interpret that such double pressing may mean that the operational speed to the surgical tool 102 needs to be increased (e.g., double the speed). Prior to performing the desired action, the microcontroller 304 may be configured to determine the location data of the surgical tool 102 (e.g., either using its own circuitry and/or using tracking/navigation system(s) 106 and/or computing system(s) 108 (as shown in FIG. 1)), and if the location data substantially matches the actuation location, the microcontroller 304 may transmit appropriate instructions to allow performance of the desired action. As can be understood, any other type of instructions and/or interpretations by the microcontroller 304 and/or any of its components, circuits, etc. are possible.

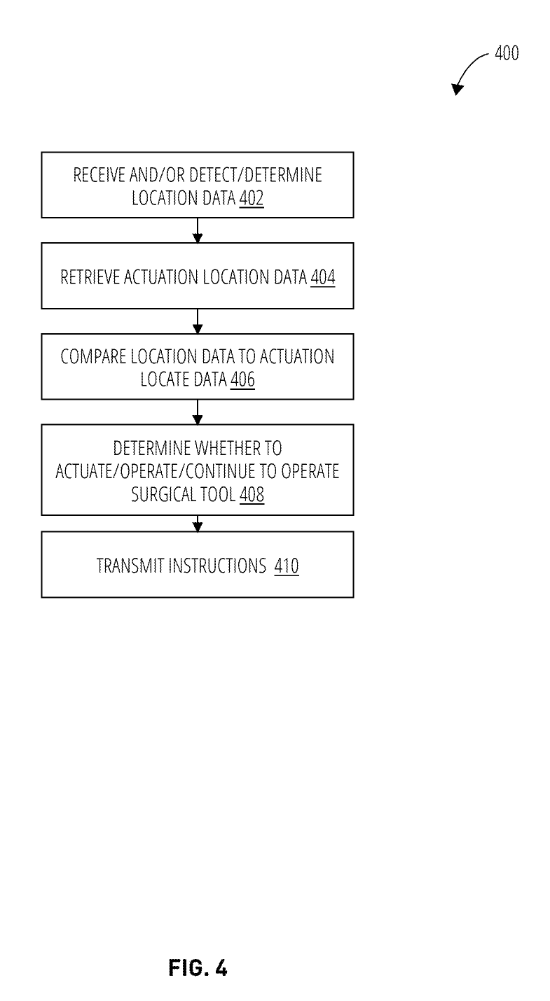

FIG. 4 illustrates a process 400 for controlling operation of the surgical tool 102, according to some examples of the current subject matter. The process 400 may be executed using surgical tool control system 100 shown in FIGS. 1-3. In particular, the tracking/navigation system(s) 106, computing system(s) 108, and/or surgical tool actuation device 104 may be configured to execute one or more operations of the process 400.

At 402, a location data related to the coordinates and/or direction of the surgical tool 102 within the surgical theater (e.g., environment of the system 100) may be received and/or determined and/or detected. The location data may be received from the tracking/navigation system(s) 106 of the system 100, which may include one or more cameras, sensors, etc. The location data may be represented as one or more coordinates, images, graphs, etc., as well as a direction of orientation of the surgical tool 102. Such location data may be determined using one or more processors of the surgical tool control system 100, including one or more processors that may be integrated into the surgical tool actuation device 104 and/or computing system(s) 108.

At 404, actuation location data may be retrieved. The actuation location data may include actuation coordinates and/or actuation direction of orientation for the surgical tool 102 at a particular point in time during the surgical procedure using the surgical tool 102 (e.g., at the start of the surgical procedure, at any time during performance of the procedure, at the end of the surgical procedure, and/or at any other time). The actuation location data may be stored in one or more storage locations and may be retrieved by the surgical tool actuation device 104 and/or computing system(s) 108. To retrieve the actuation location data, the surgical tool actuation device 104 and/or the computing system(s) 108 may be configured to issue a query to the storage location, where the query may be used to search the storage location and retrieve appropriate actuation location data that is responsive to the query. In some examples, the actuation location data may be retrieved continuously to ensure that the surgical tool 102 is properly positioned at every point during the surgical procedure for the purposes of determining whether its actuation/operation/continuous operation may or may not be possible.

In some examples, the actuation location data may be predetermined by the surgical treatment plan that may describe the surgical procedure. Alternatively, or in addition, the actuation location data may be determined using one or more historical surgical procedures (e.g., using a machine learning model, and/or in any other way), where the historical surgical procedures may be of the same type (e.g., implant positioning, etc.) as the surgical procedure that is currently being performed.

At 406, one or more processors of surgical tool actuation device 104 and/or computing system(s) 108 may be configured to compare the location data with the retrieved actuation location data. The comparison may involve a comparison of position coordinates of the surgical tool 102 to the actuation position coordinates and a comparison of direction of orientation of the surgical tool 102 to the actuation direction of orientation.

At 408, based on the comparisons, one or more processors of the surgical tool actuation device 104 and/or computing system(s) 108 may be configured to determine whether the location data substantially matches the retrieved actuation location data. This determination may be made based on the comparison of coordinates and the comparison of directions. If one of them does not match, the surgical tool 102 may be prevented from actuating/operating/continuing to operate. The match may be determined to exist based on one or more of the coordinates and/or the directions being within a predetermined number of degrees of freedom (e.g., 3-6 degrees of freedom). In some examples, the match between location data and actuation location data may need to be exact (e.g., based on a specific type of surgical procedure). This may ensure that errors due to improper positioning of the surgical tool 102 may be avoided during the surgical procedure.

Based on the determination, one or more instructions may be transmitted, at 410, from the surgical tool actuation device 104 and/or computing system(s) 108 to the surgical tool 102 and/or from the computing system(s) 108 to the surgical tool actuation device 104 to actuate/operate/continue to operate the surgical tool 102 and/or prevent actuation/operation/ continuous operation of the surgical tool 102. The instructions may be transmitted dynamically, periodically, and/or on continuous basis. This may allow close control of the operation of the surgical tool 102 during the surgical procedure.

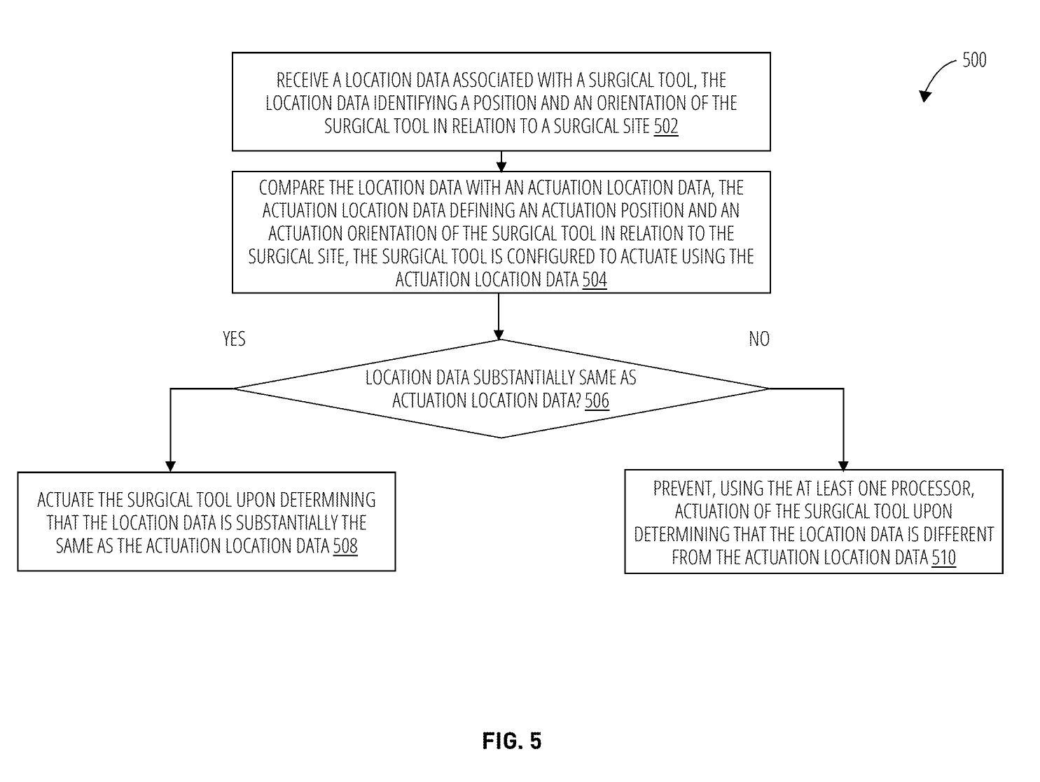

FIG. 5 illustrates another example process 500 for controlling operation of the surgical tool 102, according to some examples of the current subject matter. The process 500 may be executed using surgical tool control system 100 shown in FIGS. 1-3. In particular, the tracking/navigation system(s) 106, computing system(s) 108, and/or surgical tool actuation device 104 may be configured to execute one or more operations of the process 500.

At 502, the system 100 may receive, using one or more of its processors (e.g., incorporated into the tracking/navigation system(s) 106, computing system(s) 108, and/or surgical tool actuation device 104), a location data associated with a surgical tool (e.g., surgical tool 102). The location data may identify a position (e.g., coordinates) and an orientation (e.g., direction of orientation) of the surgical tool in relation to a surgical site.

At 504, the system 100 may compare the location data with an actuation location data (e.g., retrieved by the surgical tool actuation device 104 and/or computing system(s) 108 from a storage location). The actuation location data may define an actuation position and an actuation orientation of the surgical tool in relation to the surgical site. The surgical tool may be configured to actuate using the actuation location data.

At 506, the system 100 may be configured to determine whether the location data, received at 502, substantially the same and/or substantially matches the retrieved actuation location data. If so, at 508, the system 100 (e.g., via the surgical tool actuation device 104) may actuate the surgical tool. Otherwise, at 510, the system 100 may prevent actuation of the surgical tool upon determining that the location data is different from the actuation location data.

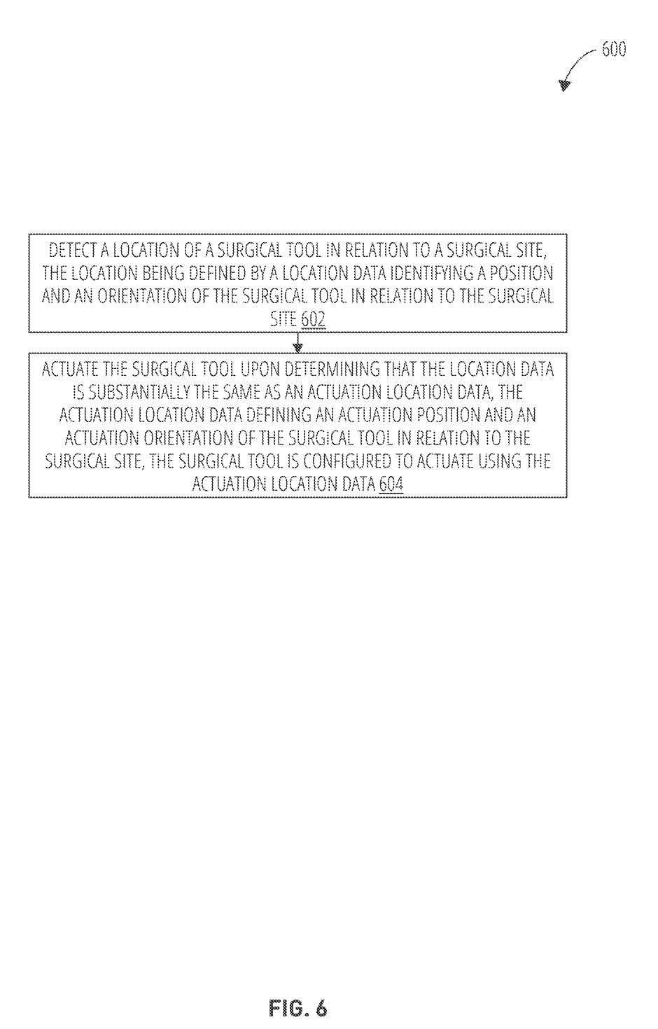

FIG. 6 illustrates yet another example process 600 for controlling operation of the surgical tool 102, according to some examples of the current subject matter. The process 600 may also be executed using surgical tool control system 100, including, for example, the tracking/navigation system(s) 106, computing system(s) 108, and/or surgical tool actuation device 104.

At 602, the system 100 (e.g., using tracking/navigation system(s) 106 and/or surgical tool actuation device 104) may detect a location of a surgical tool (e.g., surgical tool 102) in relation to a surgical site. The location may be defined by a location data identifying a position and an orientation of the surgical tool in relation to the surgical site.

At 604, the system 100 (e.g., using surgical tool actuation device 104 and/or computing system(s) 108) may actuate the surgical tool upon determining that the location data is substantially the same as an actuation location data. The actuation location data may define an actuation position and an actuation orientation of the surgical tool in relation to the surgical site.

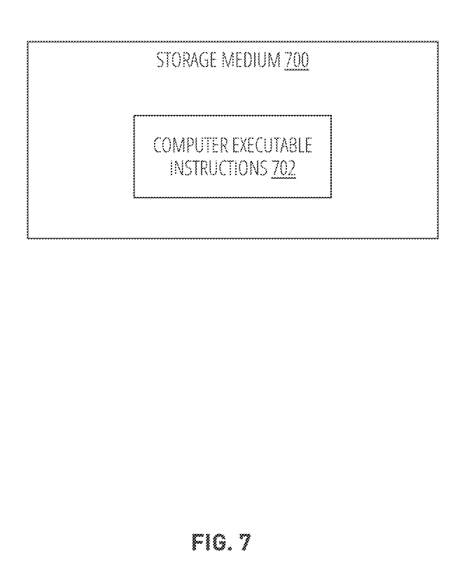

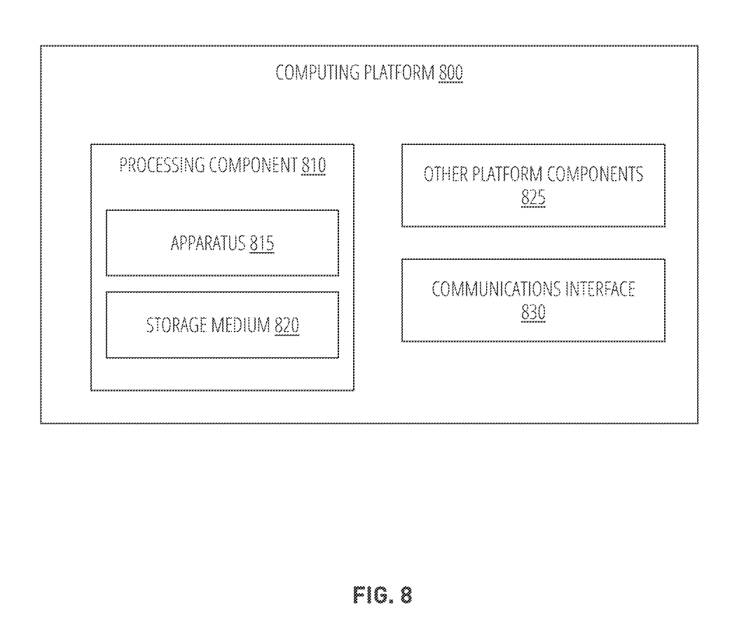

FIG. 7 and FIG. 8 illustrate example implementations of a storage medium and computing platform for an orthopedic surgical instrument or a surgical system in accordance with one or more features of the present disclosure. FIG. 7 illustrates an example of a storage medium 700 to store system logic. Storage medium 700 may include an article of manufacture. In some examples, storage medium 700 may include any non-transitory computer readable medium or machine-readable medium, such as an optical, magnetic or semiconductor storage. Storage medium 700 may store various types of computer executable instructions 702, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

FIG. 8 illustrates an example computing platform 800. In some examples, as shown in FIG. 8, the computing platform 800 may include a processing component 810, other platform components 825 or a communications interface 830. According to some examples, computing platform 800 may be implemented in a computing device such as a server in a system such as a data center or server farm that supports a manager or controller for managing configurable computing resources as mentioned above. Further, the communications interface 830 may include a wake-up radio (WUR) and may be capable of waking up a main radio of the computing platform 800.

According to some examples, processing component 810 may execute processing operations or logic for apparatus 815 described herein such as the microcontroller 304, communication module 306, and/or one or more processors of the surgical tool control system 100. Processing component 810 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements, which may reside in the storage medium 820, may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 825 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 830 may include logic and/or features to support a communication interface. For these examples, communications interface 830 may include one or more communication interfaces that operate according to various communication protocols or standards to communicate over direct or network communication links. Direct communications may occur via use of communication protocols or standards described in one or more industry standards (including progenies and variants) such as those associated with the PCI Express specification. Network communications may occur via use of communication protocols or standards such as those described in one or more Ethernet standards promulgated by the Institute of Electrical and Electronics Engineers (IEEE). For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”). Network communication may also occur according to one or more OpenFlow specifications such as the OpenFlow Hardware Abstraction API Specification. Network communications may also occur according to Infiniband Architecture Specification, Volume 1, Release 1.3, published in March 2015 (“the Infiniband Architecture specification”).

Computing platform 800 may be part of a computing device that may be, for example, a server, a server array or server farm, a web server, a network server, an Internet server, a workstation, a mini-computer, a main frame computer, a supercomputer, a network appliance, a web appliance, a distributed computing system, multiprocessor systems, processor-based systems, or combination thereof. Accordingly, functions and/or specific configurations of computing platform 800 described herein, may be included or omitted in various implementations of computing platform 800, as suitably desired.

The components and features of computing platform 800 may be implemented using any combination of discrete circuitry, ASICs, logic gates and/or single chip architectures. Further, the features of computing platform 800 may be implemented using microcontrollers, programmable logic arrays and/or microprocessors or any combination of the foregoing where suitably appropriate. It is noted that hardware, firmware and/or software elements may be collectively or individually referred to herein as “logic”.

It should be appreciated that the exemplary computing platform 800 shown in the block diagram of FIG. 8 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in implementations.

One or more features of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores”, may be stored on a tangible, machine readable medium and supplied to various customers or manufacturing facilities to load into the fabrication machines that actually make the logic or processor.

The foregoing description has broad application. While the present disclosure refers to certain implementations, numerous modifications, alterations, and changes to the described implementations are possible without departing from the sphere and scope of the present disclosure, as defined in the appended claim(s). Accordingly, it is intended that the present disclosure not be limited to the described implementations. Rather these implementations should be considered as illustrative and not restrictive in character. All changes and modifications that come within the spirit of the current subject matter are to be considered within the scope of the disclosure. The present disclosure should be given the full scope defined by the language of the following claims, and equivalents thereof. The discussion of any implementation is meant only to be explanatory and is not intended to suggest that the scope of the disclosure, including the claims, is limited to these implementations. In other words, while illustrative implementations of the disclosure have been described in detail herein, it is to be understood that the inventive concepts may be otherwise variously embodied and employed, and that the appended claims are intended to be construed to include such variations, except as limited by the prior art. Unless otherwise defined, all technical terms used herein have the same meaning as commonly understood by one of ordinary skill in the art to which the disclosure belongs.

Directional terms such as top, bottom, superior, inferior, medial, lateral, anterior, posterior, proximal, distal, upper, lower, upward, downward, left, right, longitudinal, front, back, above, below, vertical, horizontal, radial, axial, clockwise, and counterclockwise) and the like may have been used herein. Such directional references are only used for identification purposes to aid the reader’s understanding of the present disclosure. For example, the term “distal” may refer to the end farthest away from the medical professional/operator when introducing a device into a patient, while the term “proximal” may refer to the end closest to the medical professional when introducing a device into a patient. Such directional references do not necessarily create limitations, particularly as to the position, orientation, or use of this disclosure. As such, directional references should not be limited to specific coordinate orientations, distances, or sizes, but are used to describe relative positions referencing particular implementations. Such terms are not generally limiting to the scope of the claims made herein. Any implementation or feature of any section, portion, or any other component shown or particularly described in relation to various implementations of similar sections, portions, or components herein may be interchangeably applied to any other similar implementation or feature shown or described herein.

It should be understood that, as described herein, an "implementation" and/or “examples” (terms used interchangeably herein) (such as illustrated in the accompanying Figures) may refer to an illustrative representation of an environment or article or component in which a disclosed concept or feature may be provided or embodied, or to the representation of a manner in which just the concept or feature may be provided or embodied. However, such illustrated implementations are to be understood as examples (unless otherwise stated), and other manners of embodying the described concepts or features, such as may be understood by one of ordinary skill in the art upon learning the concepts or features from the present disclosure, are within the scope of the disclosure. Furthermore, references to “one implementation” of the present disclosure are not intended to be interpreted as excluding the existence of additional implementations that also incorporate the recited features.

In addition, it will be appreciated that while the Figures may show one or more implementations of concepts or features together in a single implementation of an environment, article, or component incorporating such concepts or features, such concepts or features are to be understood (unless otherwise specified) as independent of and separate from one another and are shown together for the sake of convenience and without intent to limit to being present or used together. For instance, features illustrated or described as part of one implementation can be used separately, or with another implementation to yield a still further implementation. Thus, it is intended that the present subject matter covers such modifications and variations as come within the scope of the appended claims and their equivalents.

As used herein, an element or step recited in the singular and proceeded with the word “a” or “an” should be understood as not excluding plural elements or steps, unless such exclusion is explicitly recited. It will be further understood that the terms “includes” and/or “comprising,” or “includes” and/or “including” when used herein, specify the presence of stated features, regions, steps, elements and/or components, but do not preclude the presence or addition of one or more other features, regions, integers, steps, operations, elements, components and/or groups thereof.

The phrases “at least one”, “one or more”, and “and/or”, as used herein, are open-ended expressions that are both conjunctive and disjunctive in operation. The terms “a” (or “an”), “one or more” and “at least one” can be used interchangeably herein.

Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative to sizes reflected in the drawings attached hereto may vary.

The foregoing discussion has been presented for purposes of illustration and description and is not intended to limit the disclosure to the form or forms disclosed herein. For example, various features of the disclosure are grouped together in one or more implementations or configurations for the purpose of streamlining the disclosure. However, it should be understood that various features of the certain implementations or configurations of the disclosure may be combined in alternate implementations or configurations. Moreover, the following claims are hereby incorporated into this detailed description by this reference, with each claim standing on its own as a separate implementation of the present disclosure.

What is claimed is:

1. A computer-implemented method, comprising:
receiving, using at least one processor, a location data associated with a surgical tool, the location data identifying a position and an orientation of the surgical tool in relation to a surgical site;
comparing, using the at least one processor, the location data with an actuation location data, the actuation location data defining an actuation position and an actuation orientation of the surgical tool in relation to the surgical site, the surgical tool is configured to actuate in accordance with the actuation location data;
actuating, using the at least one processor, the surgical tool upon determining that the location data is substantially the same as the actuation location data; and
preventing, using the at least one processor, actuation of the surgical tool upon determining that the location data is different from the actuation location data.

2. The method of claim 1, wherein an actuation device includes the at least one processor, wherein the actuation device is configured to be communicatively coupled to the surgical tool.

3. The method of claim 2, wherein the actuation device is mechanically coupled to the surgical tool.

4. The method of claim 1, wherein the actuation location data is at least one of: a stored actuation location data, an actuation location data defined by a surgical treatment plan, or any combination thereof.

5. The method of claim 1, wherein the comparing includes
comparing the identified position of the received location data to the actuation position; and
comparing the identified location of the received location data to the actuation orientation.

6. The method of claim 5, wherein the actuating includes actuating the surgical tool upon
the identified position of the received location data being substantially the same as the actuation position; and
the identified orientation of the received location data being substantially the same as the actuation orientation.

7. The method of claim 5, wherein the preventing includes preventing actuation of the surgical tool upon at least one of:
the identified position of the received location data being different from the actuation position,
the identified orientation of the received location data being different from the actuation orientation, or
any combination thereof.

8. The method of claim 1, wherein at least one of: the identified position of the received location data or the actuation position is defined by one or more coordinates of the surgical tool in relation to the surgical site, wherein at least one of: the identified orientation of the received location data or the actuation orientation is defined by at least one of: the one or more coordinates of the surgical tool in relation to the surgical site, a direction of the surgical tool in relation to the surgical site, or any combination thereof.

9. The method of claim 1, wherein the actuating includes triggering a supply of power to the surgical tool, wherein the surgical tool is configured to actuate using the supplied power.

10. The method of claim 1, wherein the actuating includes actuating the surgical tool upon determining that the location data is within a predetermined number of degrees of freedom in relation to the actuation location data.

11. A surgical system, comprising:
a surgical tool configured for performing a surgical procedure at a surgical site; and
an actuation device communicatively coupled to the surgical tool and includes
at least one processor; and
at least one memory storing instructions that, when executed by the at least one processor, cause the at least one processor to:
receive a location data associated with the surgical tool, the location data identifying a position and an orientation of the surgical tool in relation to the surgical site;
compare the location data with an actuation location data, the actuation location data defining an actuation position and an actuation orientation of the surgical tool in relation to the surgical site, the surgical tool is configured to actuate in accordance with the actuation location data;
actuate the surgical tool upon determining that the location data is substantially the same as the actuation location data; and
prevent actuation of the surgical tool upon determining that the location data is different from the actuation location data.

12. The system of claim 11, wherein the actuation location data is at least one of: a stored actuation location data, an actuation location data defined by a surgical treatment plan, or any combination thereof.

13. The system of claim 11, wherein comparison of the location data includes
comparing the identified position of the received location data to the actuation position; and
comparing the identified location of the received location data to the actuation orientation.

14. The system of claim 13, wherein actuation of the surgical tool includes actuating the surgical tool upon
the identified position of the received location data being substantially the same as the actuation position; and
the identified orientation of the received location data being substantially the same as the actuation orientation.

15. The system of claim 13, wherein preventing actuation includes preventing actuation of the surgical tool upon at least one of:
the identified position of the received location data being different from the actuation position,
the identified orientation of the received location data being different from the actuation orientation, or
any combination thereof.

16. The system of claim 11, wherein at least one of: the identified position of the received location data or the actuation position is defined by one or more coordinates of the surgical tool in relation to the surgical site.

17. The system of claim 16, wherein at least one of: the identified orientation of the received location data or the actuation orientation is defined by at least one of: the one or more coordinates of the surgical tool in relation to the surgical site, a direction of the surgical tool in relation to the surgical site, or any combination thereof.

18. The system of claim 11, wherein the actuating includes triggering a supply of power to the surgical tool, wherein the surgical tool is configured to actuate using the supplied power.

19. The system of claim 11, wherein the actuating includes actuating the surgical tool upon determining that the location data is within a predetermined number of degrees of freedom in relation to the actuation location data.

20. A surgical tool configured for performing a surgery at a surgical site, comprising:
an actuation device configured to
receive a location data associated with the surgical tool, the location data identifying a position and an orientation of the surgical tool in relation to the surgical site;
compare the location data with an actuation location data, the actuation location data defining an actuation position and an actuation orientation of the surgical tool in relation to the surgical site, the surgical tool is configured to actuate in accordance with the actuation location data;
actuate the surgical tool upon determining that the location data is substantially the same as the actuation location data; and
prevent actuation of the surgical tool upon determining that the location data is different from the actuation location data.
